(19) United States
(12) Patent Application Publication
(10) Pub. No.: US 2016/0372904 A1
(43) Pub. Date: Dec. 22, 2016

(54) ELECTRICAL JUNCTION BOX

(71) Applicant: Yazaki Corporation, Tokyo (JP)

(72) Inventors: Makoto NAKAYAMA, Makinohara-shi (JP); Takahiko MITSUI, Makinohara-shi (JP); Ryo NAKANO, Makinohara-shi (JP)

(21) Appl. No.: 14/901,801

(22) PCT Filed: Jul. 14, 2014
(86) PCT No.: PCT/JP2014/068670

§ 371 Date: Dec. 29, 2015

(30) Foreign Application Priority Data
Jul. 16, 2013 (JP) 2013-147499

(51) Int. Cl. H02G 3/16; H02G 3/08; H01R 13/58

(52) U.S. Cl. CPC H02G 3/16; H01R 13/5833; H02G 3/083; H01R 2201/26

(57) ABSTRACT

The present invention provides an electrical junction box capable of preventing breakage of a wire member led out to the outside a box body. A control electric wire has a length dimension that is equal to the sum of a routing length for routing an electric wire member composed of the control electric wire and a control connector along the route of an electric wire guiding portion that guides the electric wire member down to a connector retaining portion, and an extra mating length for fitting the control connector in the connector retaining portion. By the control electric wire slackened by an amount equal to the excessive mating length, the control electric wire abuts against a blocking wall continuing to a first outside surface that is provided so as to face a fixing target.

### TECHNICAL FIELD

The present invention relates to electrical junction box mounted on vehicle.

### BACKGROUND ART

The electrical junction box mounted on vehicles typically includes electrical components such as relays, fuses, fusible links or the like, a box body (casing body) made of insulation resin accommodating such electrical components, and external terminals electrically connecting the electrical components and external apparatuses. Further, an affixing portion provided in the box body is affixed on a vehicle panel by bolts. It is likely that when such an electrical junction box accommodates electrical components (i.e., relay) which generate noises or vibrations, the emitted noises or vibrations is transmitted to the vehicle body as solid-borne noises via the box body so as to make passengers feel uncomfortable. Under such a circumstance, the electrical junction box in which noise insulating properties are taken into account has been proposed (refer to PTL 1).

The electrical junction box described in PTL 1 is configured to include a relay, an electrical circuit substrate and an apparatus body (casing body), and the relay is mounted on the electrical circuit substrate via a cushion material by which the transmission of noises or vibrations is prevented.

However, even if the cushion material is provided, the noises or the vibrations emitted from the electrical component may be transmitted to the box body (casing body). In view of this, a structure has been proposed in which a cushion member like brush is provided onto an outside surface of a resin molding product (casing body), and by using the cushion member, the noises or the vibrations transmitted to the vehicle body are made suppressed (refer to PTL 2).

### CITATION LIST

### Patent Literature

PTL 1: JP 2000-164097 A

PTL 2: JP 2000-350332 A

### SUMMARY OF INVENTION

### Technical Problem

Incidentally, the electrical junction box is likely to be provided with the electric wire member such as a control wire connected to the ECU or the like mounted in a vehicle so as to control the operation of the electrical component embedded therein. Such an electric wire member is led out to the outside of the box body, and a connector for connecting to the wire harness from the ECU or the like is provided at the tip of the electric wire member that has been led out. However, in a case where the electric wire member is provided being exposed to the outside of the box body, the electric wire member is scraped by a fixing target due to vibrations of the electrical components or vibrations of the motor vehicles, thereby, breakage or disconnection may be caused.

In view of the above, the present invention aims to provide the electrical junction box capable of preventing the breakage of the electric wire member from being exposed to the outside of the box body.

### Solution to Problem

In order to attain the above described objectives, one aspect of the present invention provides an electrical junction box including: an electrical component; a casing body for accommodating the electrical component, the casing body affixed to a fixing target and made of insulation resin; and an electric wire member connected to the electrical component and led out to the outside of the casing body, wherein the electric wire member is configured to include an electric wire portion connected to the electrical component and a connector connected to a tip of the electric wire portion and retained at outside of the casing body, wherein the casing body is formed to include a first outer surface potion facing the fixing target, a second outer surface potion provided in an inner position that is further apart from the fixing target than the first outer surface potion, an accommodation portion accommodating the electrical component, a connector retaining portion which has the connector fitted therein to retain the connector, an electric wire guiding portion that guides the electric wire member from the accommodation portion to the connector retaining portion, and a blocking wall portion continuing to the first outer surface potion and capable of abutting against the electric wire portion, wherein the electric wire guiding portion is formed to include a first lead-out portion which leads the electric wire member out from the accommodation portion, a second lead-out portion provided at the second outer surface potion and leading the electric wire member out to the outside of the electrical junction box, a first guiding portion which guides the electric wire member led out to the outside of the electrical junction box to the connector retaining portion, and a second guiding portion provided at a fitting-direction-rearward side in the connector retaining portion, the second guiding portion being capable of abutting against the electric wire portion, wherein the electric wire portion has a length dimension that is equal to a sum of a routing length required to be routed along a route of the electric wire guiding portion and an excessive mating length required to have the connector fitted in the connector retaining portion, and wherein the electric wire portion which slackens by the excessive mating length between the second lead-out portion and the first guiding portion, abuts against the blocking wall portion so as to restrict a protrusion of the electric wire portion further toward the fixing target side than the first outer surface potion.

A first preferred aspect of the present invention according to one aspect of the present invention is the electrical junction box wherein the blocking wall portion protrudes in a cantilever manner from the first outer surface potion and faces the second outer surface potion, and is provided to cover the fixing target side of the second lead-out portion and the first guiding portion.

### Advantageous Effects of Invention

According to the one aspect of the present invention, since the electric wire portion has the length dimension that is equal to the sum of the routing length and the excessive mating length, when being routed at the electric wire guiding portion in a state where the electric wire portion slackens by the excessive mating length, the electric wire portion abuts against the blocking wall portion and a protrusion of the electric wire further toward the fixing target side is restricted. Thereby, the electric wire portion is prevented from being rubbed by the fixing target. Thus, even when the electrical component vibrates, or the relative displacement occurs between the fixing target and the casing body, these vibrations, and breakage or disconnection of the electric wire portion due to the relative displacement can be prevented. Further, exterior members for protecting the electric wire portion become needless. Thereby, the number of components can be reduced and the electrical junction box can be downsized by the reduction of the routing space.

According to the first preferred aspect of the present invention, since there is formed the blocking wall portion which protrudes in a cantilever manner from the first outer surface potion so as to face the second outer surface potion, an opening is formed between the tip side of the cantilever blocking wall portion and the second outer surface potion, a routing operation of the electric wire member is facilitated by using the opening and the workability of the assembly of the electrical junction box can be enhanced. Furthermore, by covering the fixing target side of the second lead-out portion and the first guiding portion with the blocking wall portion, the electric wire portion routed from the second control lead-out portion to the first guiding portion can be concealed and the further protrusion of the control electric wire slackened by an amount equal to the excessive mating length, can be prevented.

### BRIEF DESCRIPTION OF THE DRAWINGS

FIG. 1 is a perspective view of the electrical junction box according to the first embodiment of the present invention.

FIG. 2 is an exploded perspective view of the electrical junction box.

FIG. 3 is a perspective view of the electrical component accommodated in the casing body.

FIG. 4 is an upper facial view of the casing body.

FIG. 5 is a right side facial view of the casing body.

FIG. 6 is a view of a bottom face of the casing body.

FIG. 7 is a sectional view indicated by arrow A line in FIG. 6.

FIG. 8 is a sectional view indicated by arrow B line in FIG. 6.

FIG. 9 is an upper face view of the electrical junction box.

FIG. 10 is a bottom face view of the electrical junction box in a state where the accommodation portion is exposed and the electric wire is removed.

FIG. 11A is a side view at which the control connector is provided, in the electrical junction box.

FIG. 11B is a cross-sectional view indicated by arrow C line in FIG. 9.

FIG. 12 is an enlarged view of the area indicated by the circle D in FIG. 10.

### DESCRIPTION OF EMBODIMENTS

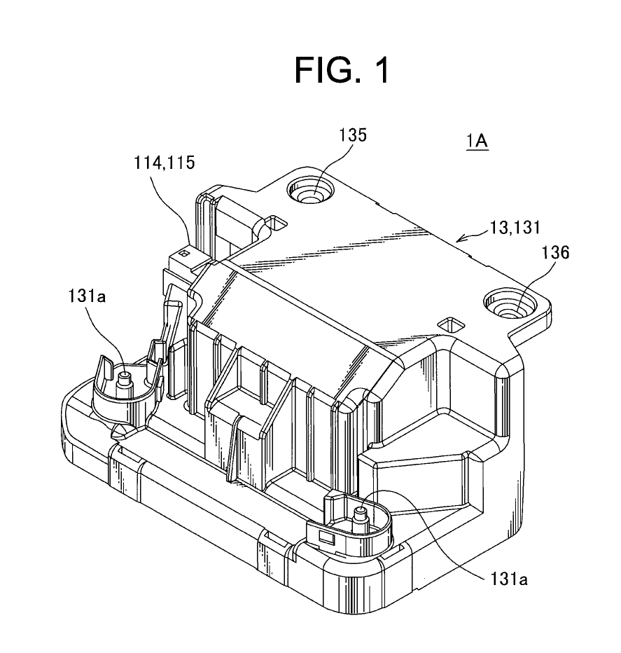

The electrical junction box according to a first embodiment of the present invention is described with reference to FIGS. 1 to 12.

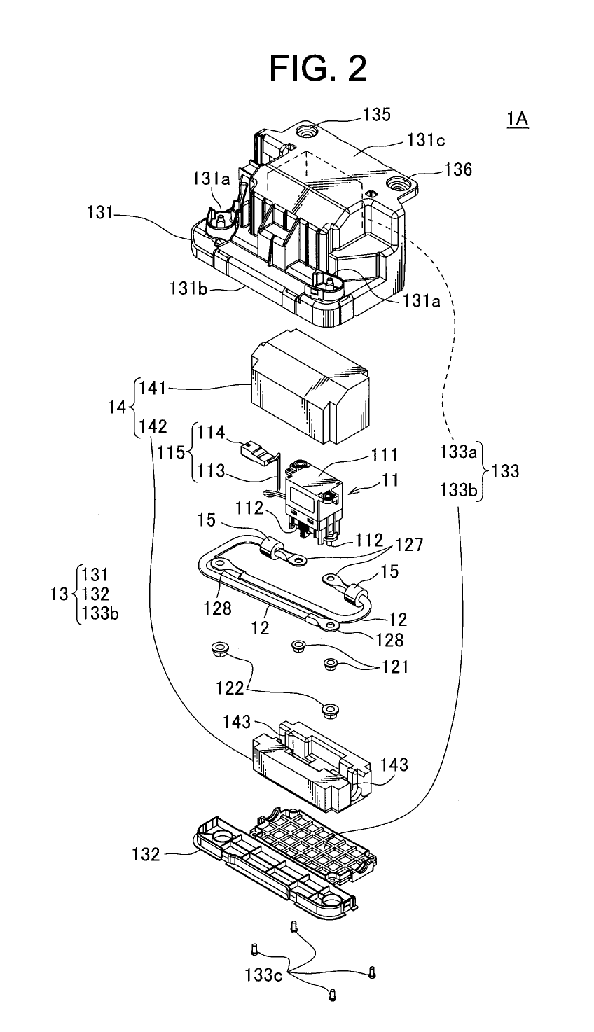

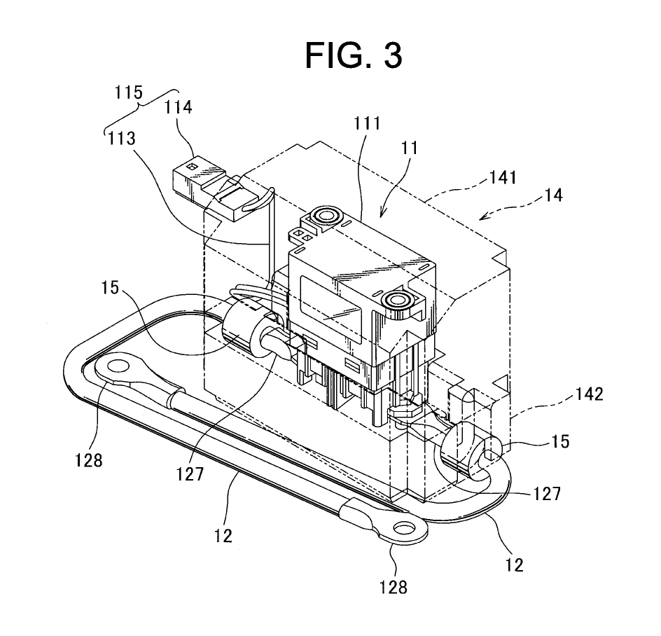

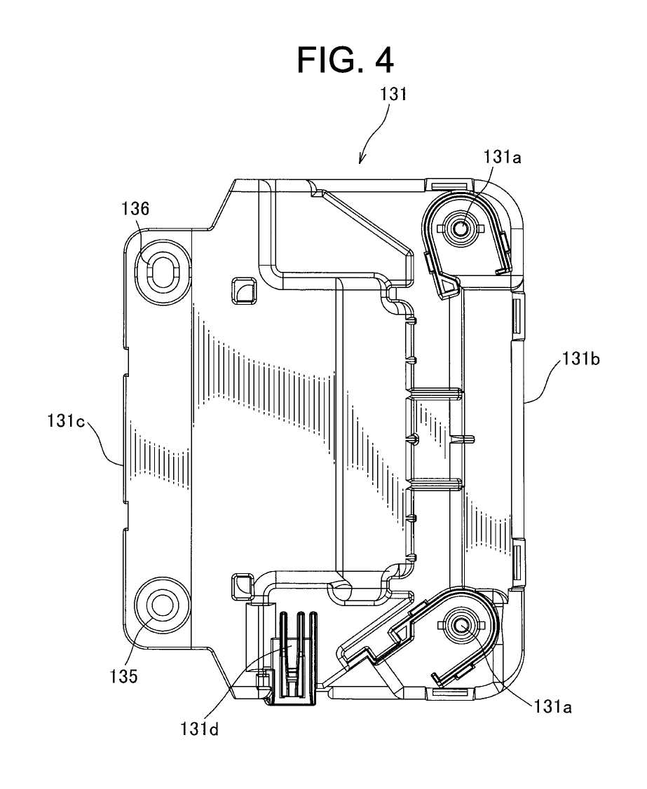

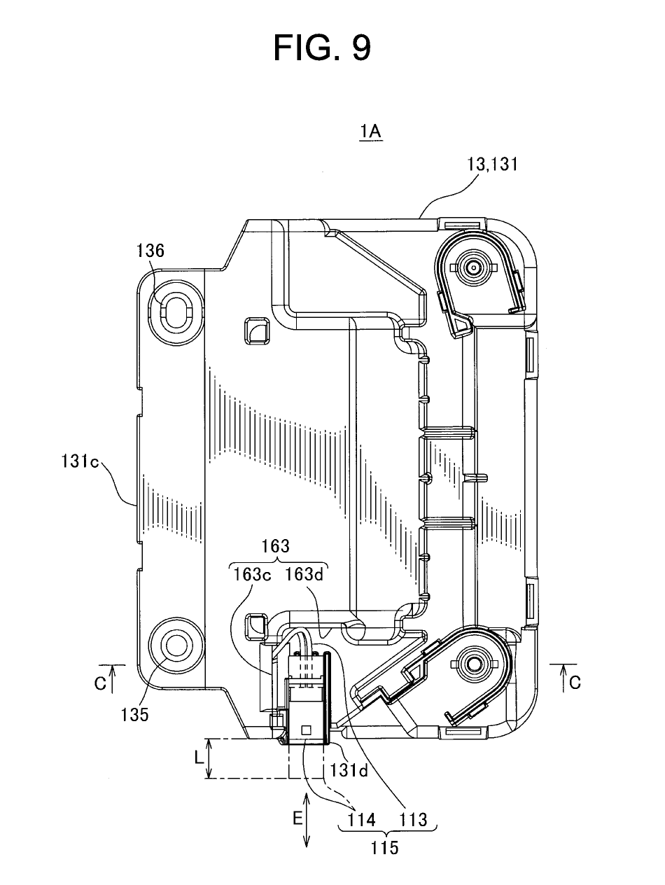

An electrical junction box 1A is mounted, for example, on a vehicle having idling stop function, and in normal driving mode of the vehicle, as for a plurality of large-capacity batteries, the electrical junction box 1A supplies electrical power to many types of electrical components from all of the batteries, while in idling mode of the same, the electrical junction box 1A implements current-applying control by which supplying electrical power from the batteries is stopped, reserving a part of the electrical power for charging. The electrical junction box 1A includes a relay 11 having a large capacity as an electrical component, an electric wire 12 for electrification connected to a terminal 112 of the relay 11, and a casing body 13 in which the relay 11 is accommodated. FIG. 1 is a perspective view of the electrical junction box 1A, and FIG. 2 is an exploded perspective view of the electrical junction box 1A. Further, FIG. 3 is a perspective view of the relay 11 accommodated in the casing body 13. Further, FIGS. 4-8 are views explaining a casing body 131 constituting the casing body 13 and FIGS. 9-12 are views explaining a route of a control electric wire 113 down to a control connector 114 that will be described later.

As shown in FIG. 2, the relay 11 includes a relay body 111, a pair of the terminals 112 to which the electric wire 12 is connected, and an electric wire member 115 connected to the relay body 111 and led out to the outside of the casing body 13. The electric wire member 115 is composed of the control electric wire 113, and the control connector 114 connected to the tip of the control electric wire 113. The control connector 114 is connected to the tip of the control electric wire 113 so as to be exposed to the outside of the electrical junction box 1A in appearance. The control electric wire 113 reaches the control connector 114 by passing through a route that will be described later. The control connector 114 is connected to a connector of an external control electric wire which is not shown. Then, control signals are transmitted to the relay 11 via the control connector 114, the control electric wire 113, and the external control electric wire so as to open and close the inner contact of the relay 11, and opening and closing operations of the inner contact of the relay 11 are performed in response to the control signals.

In the electric wire 12, first end round terminals 127 are connected to the terminals 112 of the relay 11 by nuts 121, and second end round terminals 128 are connected to external connection terminals 131a by nuts 122. The electrical junction box 1A is provided with a pair of the electric wire s 12.

The casing body 13 is configured with the casing body 131 made of synthetic resin, a cover member 132 made of synthetic resin partially covering the lower end portion of the casing body 131 and affixed to the casing body 131 by engagement of engaging claws, and a cover portion 133b covering a hole 133a that opens to a remaining part of the lower end portion of the casing body 131 and affixed to the casing body 131 by screws 133c. The hole 133a will be described later. The casing body 13 is formed to include an accommodation portion 133 which contactlessly accommodates the relay 11 in a manner surrounding the relay 11, and lead-out portions 134 through which the electric wire s 12 are led out from the accommodation portion 133.

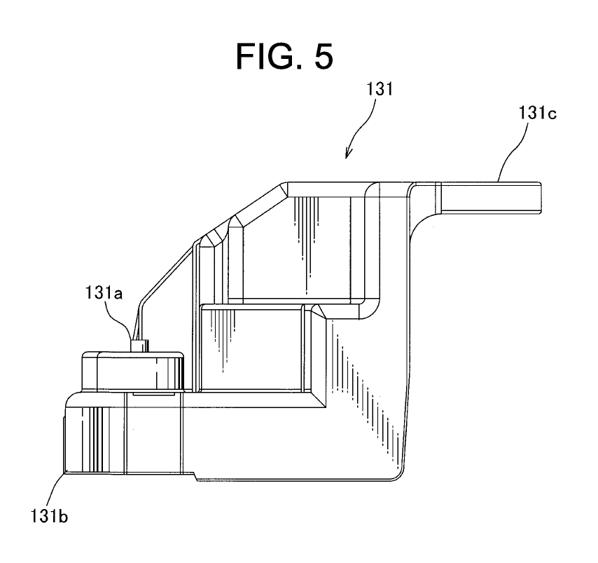

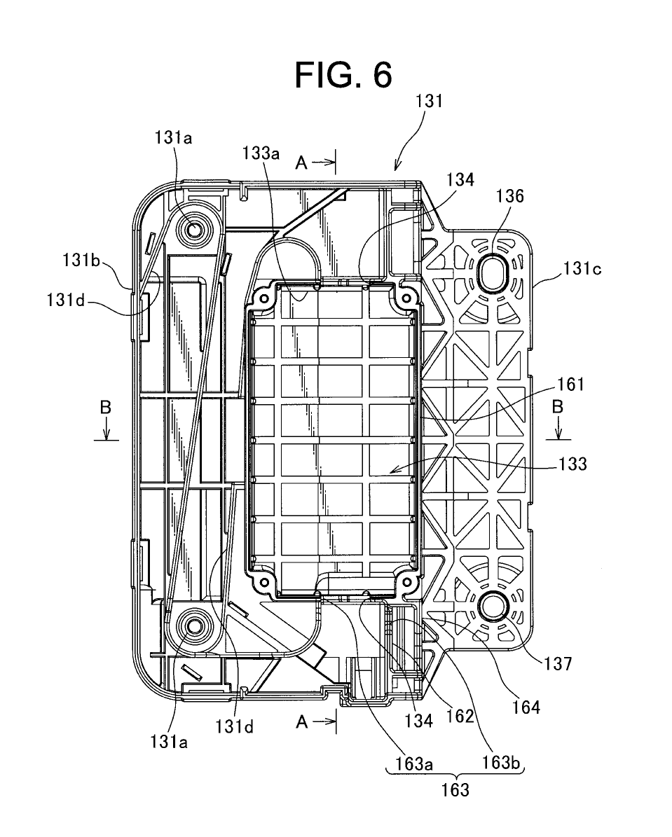

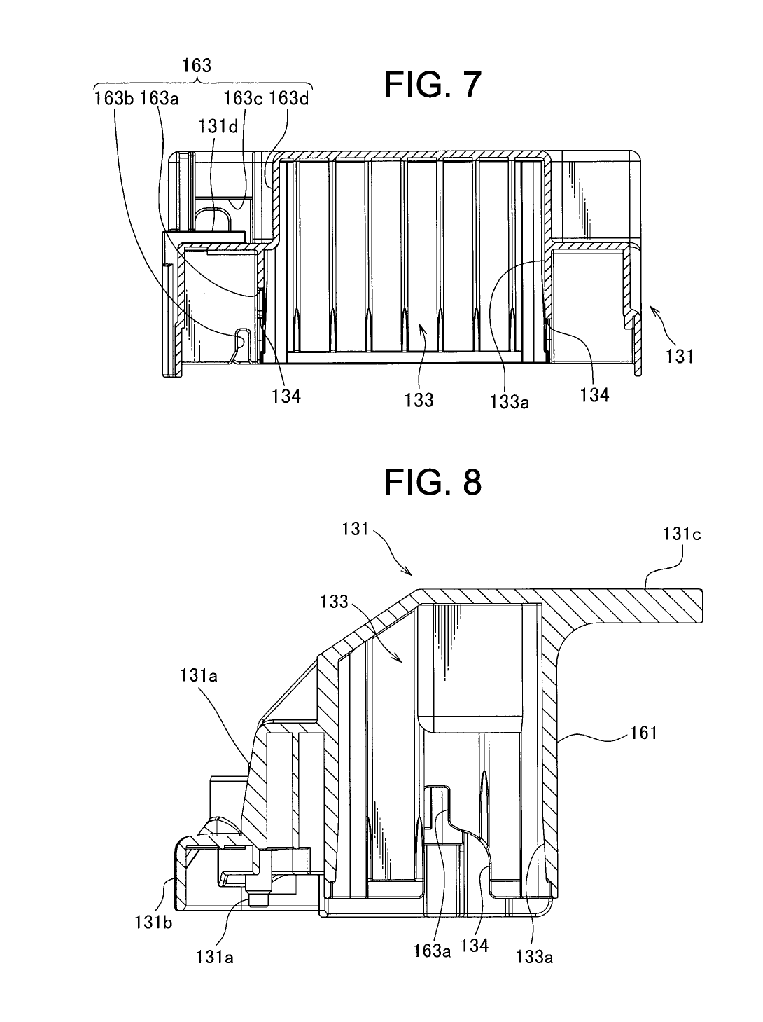

Hereinafter, the casing body 131 is described with reference to FIGS. 4 to 8. FIG. 4 is a view of the upper face of the casing body 131, FIG. 5 is a right side facial view of the casing body 131, FIG. 6 is a view of the bottom face of the casing body 131, FIG. 7 is a sectional view indicated by arrow A line in FIG. 6, and FIG. 8 is a sectional view indicated by arrow B line in FIG. 6.

The casing body 131 includes a lower periphery projection part 131b which is formed by the lower periphery located at the cover member 132 side and projecting forward. At each of the right and left end sides of the lower periphery projection part 131b, there is provided the external connection terminal 131a. The cover member 132 is affixed thereto with covering the lower face of the lower periphery projection part 131b. Further, the casing body 131 includes an upper periphery projection part 131c projecting in the rearward direction that is the opposite direction to the lower periphery projection part 131b. At the right and left end sides of the upper periphery projection part 131c, there are provided collar including penetration holes 135, 136 through which bolts for affixing the electrical junction box 1A to a predetermined attachment location are to pass. In this embodiment, among the two right and left penetration holes 135, 136, the penetration hole 138 which is shown in the upper area in FIGS. 4 and 6, is formed in an elongated-hole shape. A dimensional tolerance at the positions of the penetration holes 135, 136 is absorbed by this elongated-hole shape. Further, on the upper face of the casing body 131, there is provided a connector retaining portion 131d in which the control connector 114 shown in FIGS. 2 and 3 is fitted and is retained thereby.

The accommodation portion 133 provided in the casing body 13, is configured with the hole 133a which is provided at the casing body 131 and opens downwardly, and the cover portion 133b which closes the opening of the hole 133a as shown in FIGS. 6 to 8. The relay 11 is received within the hole 133a which corresponds to the accommodation portion 133, in a posture that the terminals 112 thereof are opposing to the cover portion 133b.

The lead-out portion 134 is a cylindrical cut-out portion provided at both of the side walls of the hole 133a. The electric wire 12 in which the first end round terminal 127 is connected to the terminals 112 of the relay 11, is led out to the outside of the hole 133a through the lead-out portion 134. Further, in a rear face of the lower periphery projection part 131b, the rear face covered by the cover member 132, there is provided a pair of right and left routing grooves 131d which introduces each of the right and left electric wires 12 to the external connection terminal 131a. The electric wire 12 is firstly led out from the lead-out portion 134, and subsequently, the electric wire 12 is introduced toward the external connection terminal 131a by passing through the inside of the routing groove 131d. At the location where the electric wire 12 is introduced, a second end round terminal 128 is connected to the external connection terminal 131a. Electric wires led out from the above-described batteries and not shown various electrical equipment are connected to the external connection terminal 131a.

Further, a first control lead-out portion 163a (first lead-out portion) and a second control lead-out portion 163b (second lead-out portion) are provided in a vicinity of the lead-out portion 134 shown in FIG. 8 among the right and left lead-out portions 134. The first control lead-out portion 163a is a member which takes out the control electric wire 113 shown in FIGS. 2 and 3 from the hole 133a. The first control lead-out portion 163a leads the control electric wire 113 shown in FIGS. 2 and 3 out from the hole 133a and is formed to be a cut-out portion which is deeper than the lead-out portion 134, the first control lead-out portion 163a being continuing to the lead-out portion 134. The second control lead-out portion 163b is a member which takes out the control electric wire 113 to a route extending to the control connector 114 that is retained by the connector retaining portion 131d via the outside of the casing body 131. The second control lead-out portion 163b is formed to be a cut-out portion adjacent to the first control lead-out portion 163a.

The control electric wire 113 is led out to the outside of the casing body 131 via the first control lead-out portion 163a and the second control lead-out portion 163b, and the control connector 114 formed at the tip of the control electric wire 113 is retained by the connector retaining portion 131d. As for the route down to the first control lead-out portion 163a and the second control lead-out portion 163b of the control electric wire 113 will be describe in detail including the peripheral structures of the first control lead-out portion 163a and the second control lead-out portion 163b in the casing body 131 which forms the casing body 13.

Here, as shown in FIGS. 2 and 3, the electrical junction box 1A is configured to include an inner mold 14 supporting the relay 11 and interposed between the relay 11 and the inner face of the accommodation portion 133, and a soft tape 15 supporting the relay 11 and interposed between the electric wire 12 and the lead-out portion 134 in a state being wound by the electric wire 12.

In this embodiment, the inner mold 14 is configured to include an innermost-side member 141 provided at the innermost-side of the hole 133ain the accommodation portion 133, and an opening-side member 142 provided at opening-side of the hole 133a and at the cover portion 133b side. Each of the members is made of urethane foam as elastic material and has a vibration-free property. In each of the members, there is provided a concave in which the relay 11 is fitted. As shown in FIG. 3, the relay 11 is clamped from up and down by these two members and is accommodated in the accommodation portion 133 in a state where the relay 11 is surrounded by the inner mold 14 with no gaps therebetween. Further, when the relay 11 is being accommodated, the inner mold 14 is in close contact with the inner face of the accommodation portion 133. Further, at the right and left side faces of the opening-side member 142 which serves as the inner mold 14, an insertion portion 143 into which the electric wire 12 is inserted, is formed in a cylindrical cut-out portion-like shape.

The soft tape 15 is a resilient member and is wound around a vicinity of the first end of the electric wire 12 that is connected to the terminals 112 of the relay 11. Then, the soft tape 15 is fitted into a space that is formed by the insertion portion 143 of the opening-side member 142 in the inner mold 14 and by the lead-out portion 134 in the casing body 13.

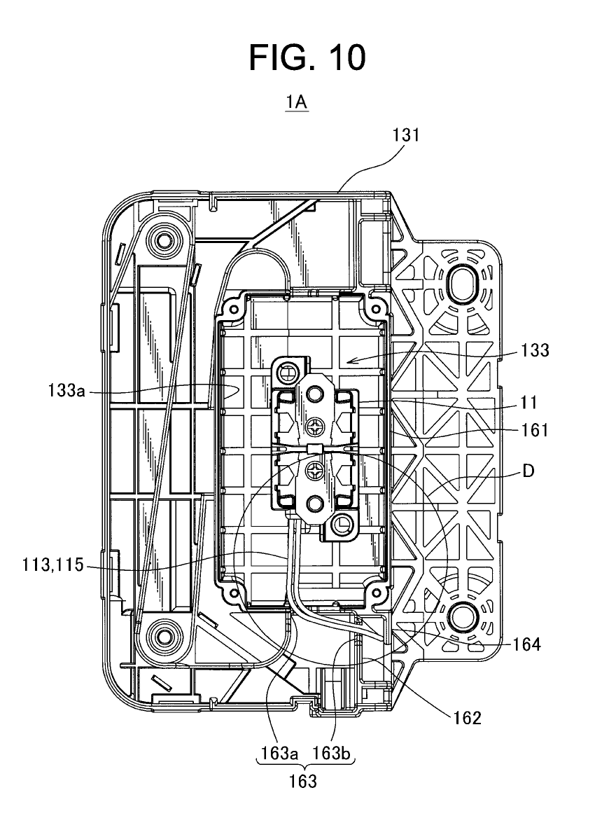

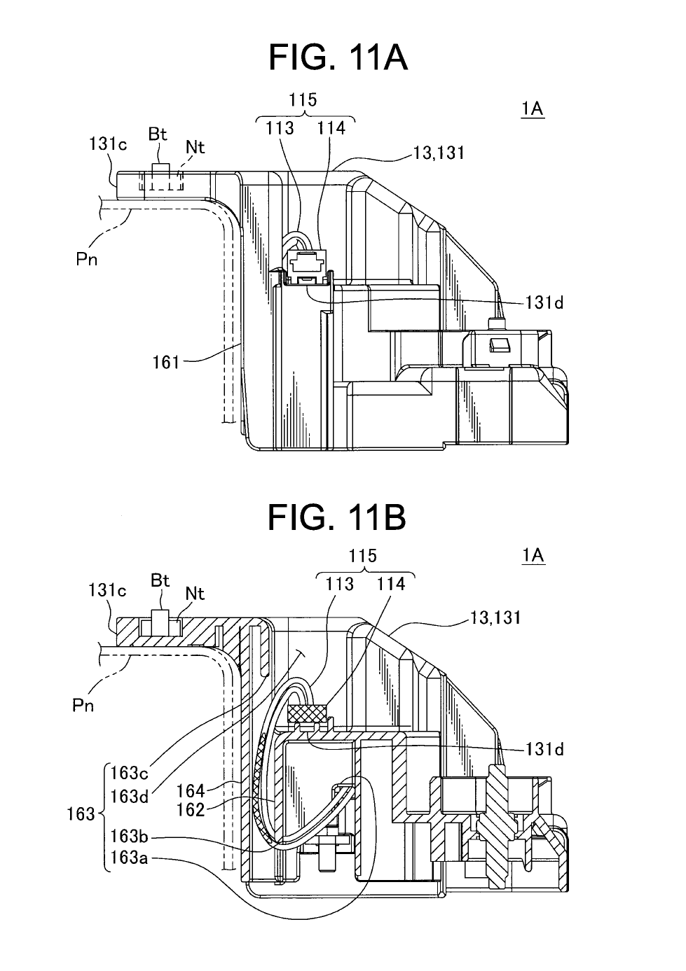

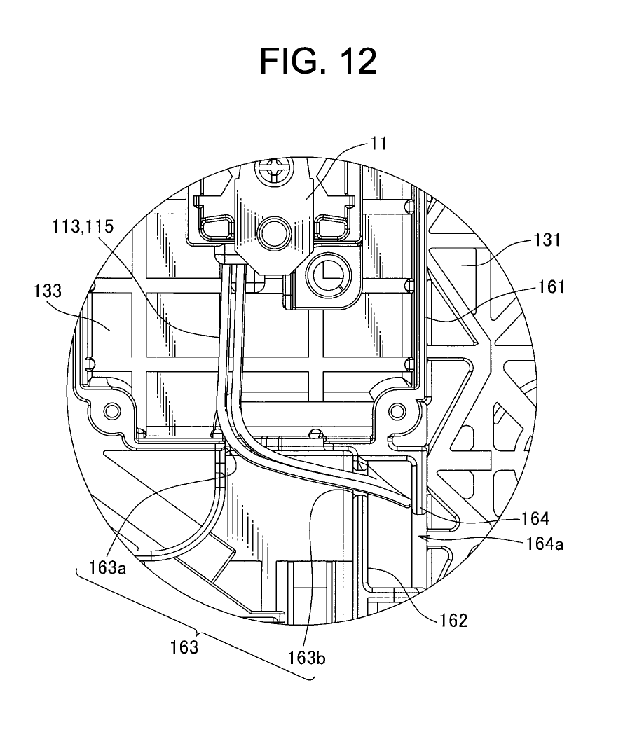

Next, a route via the first control lead-out portion 163a and the second control lead-out portion 163b of the control electric wire 113 is described with reference to FIGS. 9 to 12. FIG. 9 is the upper face view of the electrical junction box 1A, FIG. 10 is the bottom face view of the electrical junction box 1A in a state where the cover member 132 and the electric wire 12 are removed, FIG. 11A is a side view at which the control connector 114 is provided, in the electrical junction box 1A, FIG. 11B is a cross-sectional view indicated by arrow C line in FIG. 9, and FIG. 12 is an enlarged view of the area indicated by the circle D in FIG. 10.

As described above, in the outer periphery projection part 131c provided in the casing body 131 forming the casing body 13, a collar comprised of penetration holes 135, 136 through which bolts for affixing the electrical junction box 1A to a predetermined attachment place are to pass. In this embodiment, as shown in FIG. 11, the electrical junction box 1A is affixed to a vehicle body panel Pn as a fixing target in a vehicle via the outer periphery projection part 131c by bolt Bt and nut Nt.

The casing body 131 is formed to include a first outer surface potion 161 opposed to the vehicle body panel Pn, a second outer surface potion 162 provided at the inner side that is further apart from the vehicle body panel Pn than the first outer surface potion 161, an electric wire guiding portion 163 that guides the control electric wire 113 from the accommodation portion 133 down to the connector retaining portion 131d, and a blocking wall portion 164 continuing to the first outer surface potion 161 and being capable of abutting against the control electric wire 113.

The electric wire guiding portion 163 is configured to include the first control lead-out portion 163a, the second control lead-out portion 163b, a first guiding portion 163c and a second guiding portion 163d. The first control lead-out portion 163a is, as described above, a portion which leads the control electric wire 113 out from the accommodation portion 133, and the second control lead-out portion 163b is a portion which is provided at the second outer surface potion 162 and leads the control electric wire 113 to the outside of the casing body 131. Further, the first guiding portion 163c is an opening which guides the control electric wire 113 of the electric wire member 115 that is led out to the outside from the second control lead-out portion 163b to the connector retaining portion 131d. The second guiding portion 163d is a wall capable of abutting against the control electric wire 113 of the electric wire member 115, the second guiding portion 163d being provided at the fitting-direction-rearward side in the connector retaining portion 131d.

Here, the control electric wire 113 has a length dimension which is equal to a sum of a pass length that is necessary for routing along the route of the electric wire guiding portion 163 and an excessive mating length L that is necessary for moving the control connector 114 to the connector retaining portion 131d in the arrow direction E in FIG. 9 to fit the control connector 114 in the connector retaining portion 131d. Then, between the second control lead-out portion 163b and the first guiding portion 163c, the control electric wire 113 which slackens by the excessive mating length L is abutting against the blocking wall portion 164. Thereby, even when the control electric wire 113 is shaken by vibrations generated when the vehicle is driven, the control electric wire 113 is prevented from protruding further toward the vehicle body panel Pn side than the first outer surface potion 161.

As a result, the control electric wire 113 is prevented from being rubbed by the vehicle body panel Pn. Thus, even though the relay 11 is vibrated or a relative displacement between the vehicle body panel Pn and the casing body 13 occurs, breakage or disconnection of the control electric wire 113 due to the vibrations or the relative displacement can be prevented. Moreover, the electrical junction box 1A does not necessitate the exterior member (i.e., a corrugate tube or the like) for protecting the control electric wire 113, a reduction of the number of the components and a downsizing of the electrical junction box 1A due to the curtailment of the routing space, can be enabled.

Further, in the embodiment, the blocking wall portion 164 is, as shown in FIG. 12, protruding from the first outer surface potion 161 in a cantilever manner and is formed in a manner opposing to the second outer surface potion 162. Thus, an opening 164a is formed between the tip side of the blocking wall portion 164 in a cantilever manner and the second outer surface potion 162, and via this opening 164a, the routing operation of the control electric wire 113 can be easily performed, thereby, the assembly workability of the electrical junction box 1A can be enhanced. Further, the blocking wall portion 164 is provided in a manner covering vehicle body panel Pn side of the second control lead-out portion 163b and the first guiding portion 163c. Thereby, the control electric wire 113 routed from the second control lead-out portion 163b to the first guiding portion 163c can be concealed and the protrusion of the control electric wire 113 slackened by the above described excessive mating length L can be restricted.

The above-described embodiments are to merely show representative exemplifications of the present invention, the present invention is not limited to these embodiments. That is, the present invention can be implemented by various modifications without departing from the gist thereof.

For example, although in each embodiment, the electrical junction box 1A is exemplified in which only one control connector 114 is provided as an example of the electrical junction box, the electrical junction box may be provided with multiple control connectors. Further, the electrical junction box may adopt a formulation in which as for all the control electric wires that are led to each of the multiple control connectors, one electric wire guiding portion guides all the control electric wires, and one blocking wall portion restricts the movements of all the control electric wires. Alternatively, the electrical junction box may adopt a formulation in which the electric wire guiding portion and the blocking wall portion are provided in plural respectively, and each of the control electric wire is guided by the electric wire guiding portion corresponding thereto and the movement thereof is restricted by the blocking wall portion.

Further, although in each of the embodiments, the electrical junction boxes 1A accommodating one relay has been exemplified for the electrical junction box, the electrical junction box may be the one which accommodates multiple relays, or may be the one which accommodates more than one relay, a fuse, and an electrical circuit substrate or the like. The electrical junction box may be the one which accommodates electrical components other than the relay.

### REFERENCE SIGNS LIST

1A electrical junction box

11 relay

3 casing body

113 control electric wire

114 control connector

115 electric wire member

131 casing body

131d connector retaining portion

133 accommodation portion

161 first outer surface potion

162 second outer surface potion

163 electric wire guiding portion

163a first control lead-out portion (first lead-out portion)

163b second control lead-out portion (second lead-out portion)

163c first guiding portion

163d second guiding portion

164 blocking wall portion

1. An electrical junction box comprising:
an electrical component;
a casing body for accommodating the electrical component, the casing body affixed to a fixing target and made of insulation resin; and
an electric wire member connected to the electrical component and led out to the outside of the casing body, wherein
the electric wire member is configured to include an electric wire portion connected to the electrical component and a connector connected to a tip of the electric wire portion and retained at outside of the casing body, wherein
the casing body is formed to include a first outer surface potion facing the fixing target, a second outer surface potion provided in an inner position that is further apart from the fixing target than the first outer surface potion, an accommodation portion accommodating the electrical component, a connector retaining portion which has the connector fitted therein to retain the connector, an electric wire guiding portion that guides the electric wire member from the accommodation portion to the connector retaining portion, and a blocking wall portion continuing to the first outer surface potion and capable of abutting against the electric wire portion, wherein
the electric wire guiding portion is formed to include a first lead-out portion which leads the electric wire member out from the accommodation portion, a second lead-out portion provided at the second outer surface potion and leading the electric wire member out to the outside of the electrical junction box, a first guiding portion which guides the electric wire member led out to the outside of the electrical junction box to the connector retaining portion, and a second guiding portion provided at a fitting-direction-rearward side in the connector retaining portion, the second guiding portion being capable of abutting against the electric wire portion, wherein
the electric wire portion has a length dimension that is equal to a sum of a routing length required to be routed along a route of the electric wire guiding portion and an excessive mating length required to have the connector fitted in the connector retaining portion, and wherein
the electric wire portion which slackens by the excessive mating length between the second lead-out portion and the first guiding portion, abuts against the blocking wall portion so as to restrict a protrusion of the electric wire portion further toward the fixing target side than the first outer surface potion.

2. The electrical junction box according to claim 1, wherein
the blocking wall portion protrudes in a cantilever manner from the first outer surface potion and opposes to the second outer surface potion, the blocking wall portion being provided to cover the fixing target side of the second lead-out portion and the first guiding portion.
